(19) United States
(12) Patent Application Publication
(10) Pub. No.: US 2015/0138077 A1
(43) Pub. Date: May 21, 2015

(54) DISPLAY SYSTEM AND DISPLAY CONTROLL DEVICE

(71) Applicant: KABUSHIKI KAISHA TOSHIBA, Tokyo (JP)

(72) Inventors: Yuto YAMAJI, Kawasaki (JP); Tomoyuki SHIBATA, Kawasaki (JP); Isao MIHARA, Tokyo (JP); Toshiaki NAKASU, Tokyo (JP)

(73) Assignee: KABUSHIKI KAISHA TOSHIBA

(21) Appl. No.: 14/546,180

(22) Filed: Nov. 18, 2014

(30) Foreign Application Priority Data
Nov. 20, 2013 (JP) 2013-240451

(51) Int. Cl. G06F 3/00

(52) U.S. Cl. CPC G06F 3/005
USPC 345/156

(57) ABSTRACT

According to an embodiment, a display system includes an operation input receiver, a recognizer, an execution controller, and a display controller. The operation input receiver receives an operation input. The recognizer recognizes one or more information processing terminals placed on the operation input receiver. The execution controller executes a command based on the operation input that is performed through the operation input receiver. The display controller displays, on the operation input receiver, an execution result of the command so as to be associated with at least any of the one or more information processing terminals.

### CROSS-REFERENCE TO RELATED APPLICATIONS

This application is based upon and claims the benefit of priority from Japanese Patent Application No. 2013-240451, filed on Nov. 20, 2013; the entire contents of which are incorporated herein by reference.

### FIELD

Embodiments described herein relate to a display system and a display control device.

### BACKGROUND

There is conventionally known a technique of placing a plurality of devices on a table having a touch panel display and displaying on the table a transfer process of data transfer among the devices.

In the above-described conventional technique, data stored in the device is merely displayed in relation to the device on the table. For this reason, in the conventional technique described above, the result of interactive exchange between the device and the table cannot be displayed in a manner that such interactive relation is understood.

### BRIEF DESCRIPTION OF THE DRAWINGS

FIG. 1 is a schematic diagram illustrating an example of a display system according to a first embodiment;

FIG. 2 is a diagram illustrating an example of a use scene of a display system according to a first embodiment;

FIG. 3 is a configuration diagram illustrating an example of a PC according to a first embodiment;

FIG. 4 is an illustrative diagram of a method according to a first embodiment;

FIG. 5 is an illustrative diagram of a method according to a first embodiment;

FIG. 6 is an illustrative diagram of a method according to a first embodiment;

FIG. 7 is an illustrative diagram of a method according to a first embodiment;

FIG. 8 is a flowchart illustrating a processing example according to a first embodiment;

FIG. 9 is an illustrative diagram of a method according to a modification of a first embodiment;

FIG. 10 is an illustrative diagram of a method according to a modification of a first embodiment;

FIG. 11 is a schematic diagram illustrating an example of a display system according to a second embodiment;

FIG. 12 is a configuration diagram illustrating an example of a PC according to a second embodiment;

FIG. 13 is an illustrative diagram of a method according to a second embodiment;

FIG. 14 is a flowchart illustrating a processing example according to a second embodiment;

FIG. 15 is an illustrative diagram of a method according to a modification of a second embodiment;

FIG. 16 is an illustrative diagram of a method according to a modification of a second embodiment;

FIG. 17 is an illustrative diagram of a method according to a modification of a second embodiment;

FIG. 18 is an illustrative diagram of a method according to a modification of a second embodiment;

FIG. 19 is an illustrative diagram of a method according to a modification of a second embodiment;

FIG. 20 is an illustrative diagram of a method according to a modification; and

FIG. 21 is a diagram illustrating a hardware configuration example of a PC according to embodiments and modifications.

### DETAILED DESCRIPTION

According to an embodiment, a display system includes an operation input receiver, a recognizer, an execution controller, and a display controller. The operation input receiver receives an operation input. The recognizer recognizes one or more information processing terminals placed on the operation input receiver. The execution controller executes a command based on the operation input that is performed through the operation input receiver. The display controller displays, on the operation input receiver, an execution result of the command so as to be associated with at least any of the one or more information processing terminals.

Embodiments will be described in detail below with reference to the accompanying drawings.

### First Embodiment

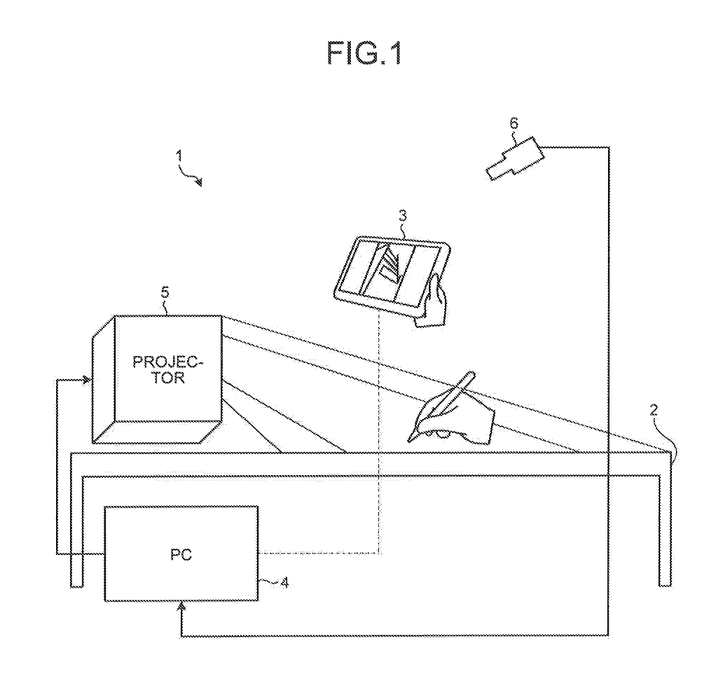

FIG. 1 is a schematic diagram illustrating an example of a display system 1 according to a first embodiment. As illustrated in FIG. 1, the display system 1 includes an operation input receiving device 2 (an example of an operation input receiver), an information processing terminal 3, a Personal Computer (PC) 4, a projector 5 (an example of a display controller), and an imaging device 6.

The operation input receiving device 2 receives an operation input, and may be, by, for example, a table having a touch panel. That is, the operation input receiving device 2 receives a touch input by a stylus pen and a finger. Here, the operation input receiving device 2 may further display an image. In this case, the operation input receiving device 2 may be a table having a touch panel display.

The information processing terminal 3 receives an operation input and displays an image. For example, the information processing terminal 3 may be a tablet terminal having a touch panel display or a smart phone.

The PC 4 controls the operation input receiving device 2. The projector 5 projects an image (a picture) on the operation input receiving device 2. The imaging device 6 images the operation input receiving device 2.

In the display system 1 according to the first embodiment, when a user places the information processing terminal 3 on the operation input receiving device 2, the PC 4 recognizes the information processing terminal 3 placed, and acquires document information stored in the information processing terminal 3. The projector 5 projects on the operation input receiving device 2 a projection image containing a search box generated by the PC 4. When a user inputs a keyword in the search box, the PC 4 retrieves, from the acquired document information, document information based on the input keyword, and generates a projection image containing the retrieved document information (an image of document information). The projector 5 projects the projection image generated by the PC 4 such that the document information contained in the projection image is associated with the information processing terminal 3.

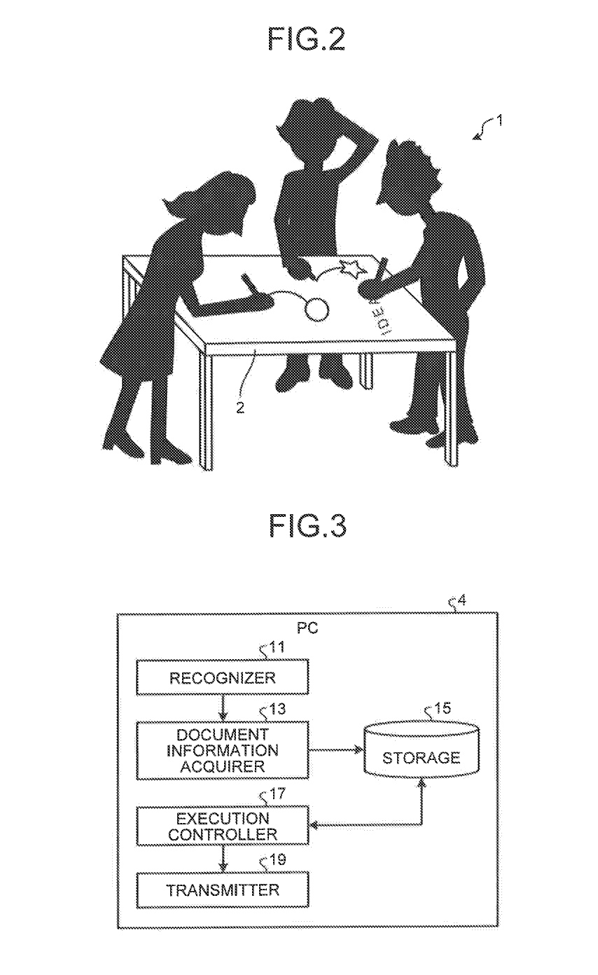

The display system 1 according to the first embodiment is assumed to, but not limited to, be used in a scene where, as illustrated in FIG. 2, a plurality of users surrounds the operation input receiving device 2 and each user places the information processing terminal 3 (not illustrated in FIG. 2) owned by the user on the operation input receiving device 2 in a meeting or the like.

FIG. 3 is a configuration diagram illustrating an example of the PC 4 according to the first embodiment. As illustrated in FIG. 3, the PC 4 includes a recognizer 11, a document information acquirer 13, a storage 15, an execution controller 17, and a transmitter 19.

The recognizer 11, the document information acquirer 13, the execution controller 17, and the transmitter 19 may be, for example, implemented by execution of a program in a processing device such as a CPU (Central Processing Unit), that is, by software; by hardware such as an IC (Integrated Circuit); or by a combination of software and hardware. The storage 15 may be, for example, a magnetically, optically, or electrically storable storage device such as an HDD (Hard Disk Drive), an SSD (Solid State Drive), a memory card, an optical disk, a ROM (Read Only Memory), and a RAM (Random Access Memory).

When one or more information processing terminals 3 are placed on the operation input receiving device 2, the recognizer 11 recognizes the one or more information processing terminals 3. Specifically, the recognizer 11 recognizes the one or more information processing terminals 3 by acquiring identification information and position information for each of the one or more information processing terminals 3. For example, the recognizer 11 may acquire the identification information and the position information for each of the one or more information processing terminals 3, using unillustrated short-distance wireless communication and the like. However, the acquisition method of the identification information and the position information is not limited thereto. The identification information may be any information as long as the information processing terminal 3 can be identified. An example of such information may include an MAC address. An example of the position information may include coordinate information on the operation surface of the operation input receiving device 2.

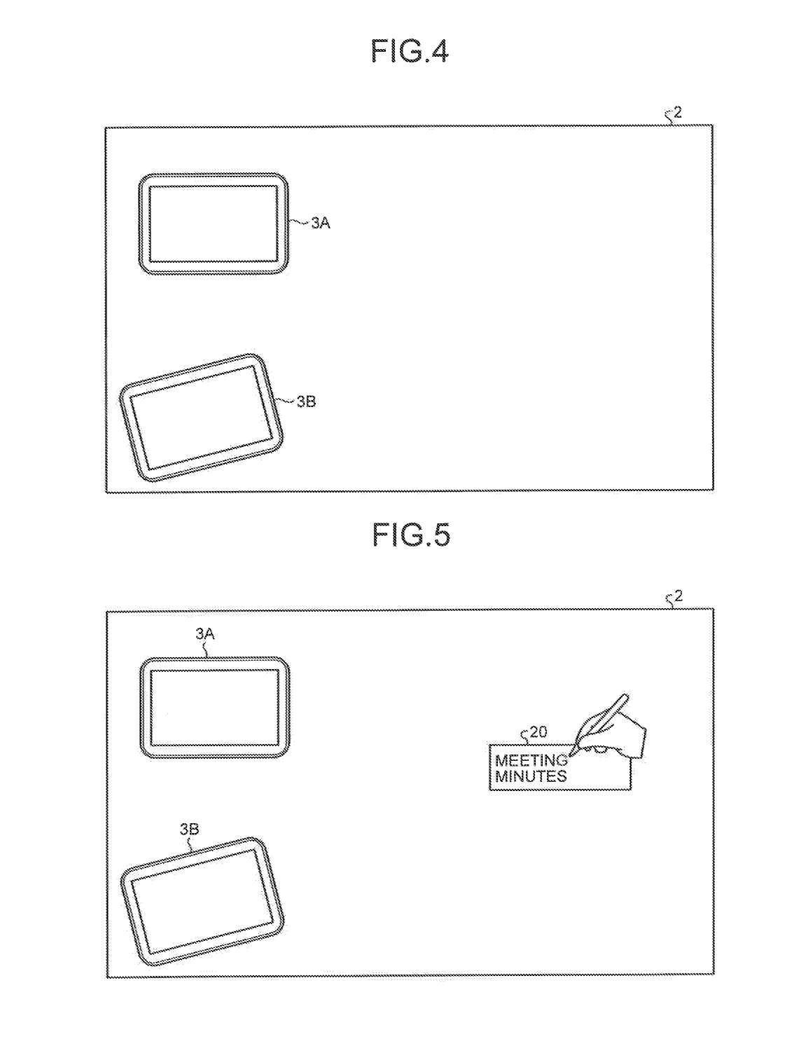

For example, as illustrated in FIG. 4, when information processing terminals 3A and 3B are placed on the operation input receiving device 2, the recognizer 11 recognizes the information processing terminals 3A and 3B by acquiring the identification information and the position information for each of the information processing terminals 3A and 3B.

The document information acquirer 13 acquires, from each of the one or more information processing terminals 3, document information stored in the information processing terminal 3, and stores the acquired document information in the storage 15. Specifically, when one or more information processing terminals 3 are recognized by the recognizer 11, the document information acquirer 13 acquires, from each of the one or more information processing terminals 3, document information stored in the information processing terminal 3, and stores in the storage 15 the acquired document information so as to be associated with the identification information of the information processing terminal 3. The document information acquirer 13 may acquire document information by, for example, communicating with the information processing terminal 3 through an unillustrated wireless LAN (Local Area Network) or a wired LAN. However, the acquisition method of document information is not limited thereto.

For example, as described in FIG. 4, when the information processing terminals 3A and 3B are recognized by the recognizer 11, the document information acquirer 13 acquires document information from each of the information processing terminals 3A and 3B. Then, the document information acquirer 13 stores in the storage 15 the document information acquired from the information processing terminal 3A so as to be associated with the identification information of the information processing terminal 3A; and stores in the storage 15 the document information acquired from the information processing terminal 3B so as to be associated with the identification information of the information processing terminal 3B.

The execution controller 17 executes a command based on an operation input that is input to the operation input receiving device 2. In the first embodiment, the execution controller 17 retrieves, from the storage 15, document information based on a keyword that is input to the operation input receiving device 2.

For example, as illustrated in FIG. 5, when a search box 20 is projected on the operation input receiving device 2 by the projector 5, a user inputs a keyword (search query) in the search box 20 with a touch pen. Accordingly, the execution controller 17 acquires the keyword from the operation input receiving device 2 to recognize the keyword as a character and retrieves, from the storage 15, document information based on the recognized keyword.

In this case, since the projection image, containing the search box 20, that is projected by the projector 5 is generated by the PC 4, the PC 4 understands the position of the search box 20. Therefore, the PC 4 may judge from the operation input receiving device 2 that the input data written by hand at the position of the search box 20 is a keyword. Alternatively, the PC 4 may judge whether or not the data written by hand is a keyword input in the search box 20, using an image of the operation input receiving device 2 imaged by the imaging device 6.

Here, the projector 5 will be described. The projector 5 displays, on the operation input receiving device 2, the command execution result of the execution controller 17 so as to be associated with at least any of one or more information processing terminals 3. Specifically, the projector 5 displays, on the operation input receiving device 2, the document information retrieved by the execution controller 17 so as to be associated with the information processing terminal 3 containing the document information acquired by the document information acquirer 13. In this case, the projector 5 displays the acquired information on the operation input receiving device 2 on a basis of the size of the operation surface of the operation input receiving device 2. Examples of a possible case in which a user displays the result of retrieval using the operation input receiving device 2 include the cases described below. Such examples include when a user wants to display the result of retrieval to be larger, or when a user wants to use the operation input receiving device 2 in order to enlarge the display region of the information processing terminal 3. Therefore, by displaying information so as to be positioned around the information processing terminal 3 as described above, user's convenience is improved in some cases.

Furthermore, the case where a user of the information processing terminal 3 having a display screen smaller than a predetermined region wants to display the result of retrieval in an enlarged manner may be considered. Therefore, a predetermined size (such as an area of a display region) may be set, and if the display screen of the information processing terminal 3 is smaller than the predetermined size, the display region may be sized larger than the display screen of the information processing terminal 3. This may be individually set for each user, or the enlargement may be performed at a predetermined magnification. Furthermore, the display region may be changed by taking advantage of indices such as an information volume to be presented. The recognizer 11 may recognize the information processing terminal 3 having a display screen smaller than size of the display region.

Although this will be described later, when a result of retrieval is displayed on the operation input receiving device 2, the list thereof may be displayed on a basis of the display surface of the information processing terminal 3.

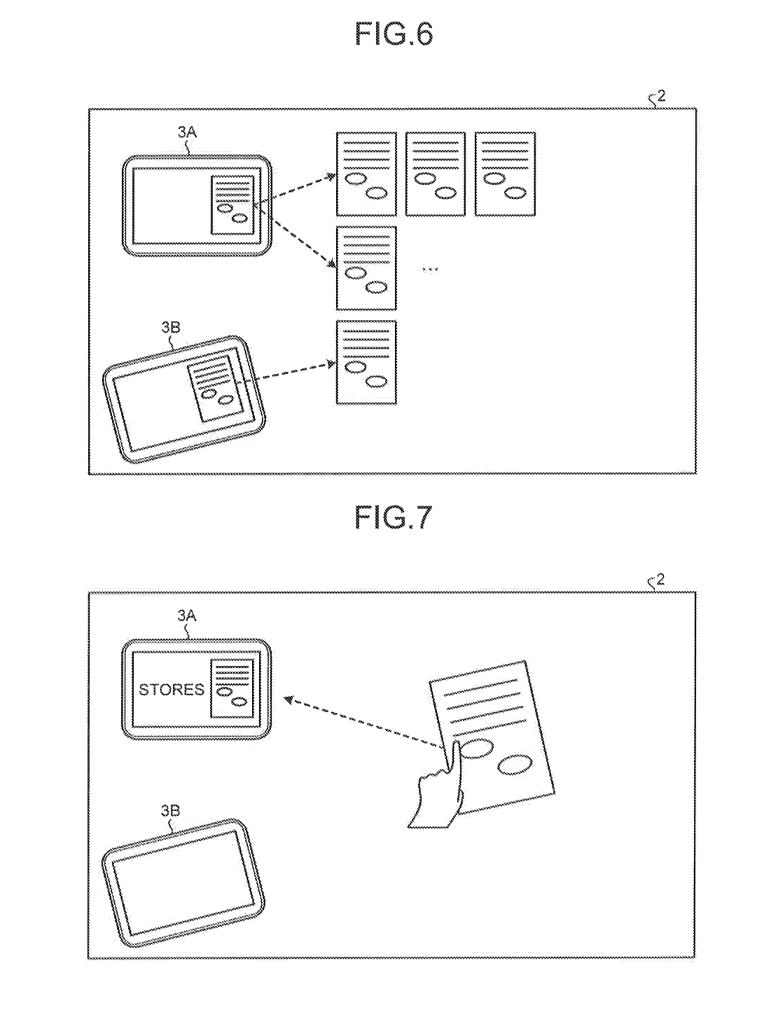

For example, as illustrated in FIG. 6, for the document information acquired from the information processing terminal 3A among the document information retrieved by the execution controller 17, the projector 5 projects the acquired document information on the operation input receiving device 2 such that the acquired document information is popped up from the information processing terminal 3A, like an animation. For the document information acquired from the information processing terminal 3B among the document information retrieved by the execution controller 17, the projector 5 projects the acquired document information on the operation input receiving device 2 such that the acquired document information is popped up from the information processing terminal 3B, like an animation.

Here, such a projection image projected by the projector 5 is generated by the PC 4. Since the document information retrieved by the execution controller 17 is associated with the identification information of the information processing terminal 3 from which the retrieved document information is acquired, the PC 4 can identify the information processing terminal 3 from which the retrieved document information is acquired. The PC 4 can also identify the position of the information processing terminal 3 from the position information of the information processing terminal 3. Therefore, the PC 4 can generate the projection image described above. Furthermore, the PC 4 may previously acquire the size of the operation surface of the operation input receiving device 2 from the operation input receiving device 2.

When a transmission operation for transmitting document information displayed on the operation input receiving device 2 to at least any of one or more information processing terminals 3 is performed on the operation input receiving device 2, the transmitter 19 transmits the document information to the information processing terminals 3.

Examples of the transmission operation may include a swipe operation and a drag-and-drop operation. The operation input receiving device 2 judges whether or not the coordinates input by a finger or a touch pen is included in the rectangle of the document information. Then, when included, the operation input receiving device 2 regards the document information as a target of the transmission operation. The operation input receiving device 2 moves the document information, which is a target of the transmission operation, by a movement amount in the x and y directions of the input coordinates. When the position of the document information after the movement is overlapped with the position of the vicinity of the information processing terminal 3, the transmitter 19 transmits the document information to the information processing terminal 3.

For example, as illustrated in FIG. 7, when an transmission operation is performed such that the document information displayed on the operation input receiving device 2 is transmitted to the information processing terminal 3A, the transmitter 19 transmits the document information to the information processing terminal 3A. Accordingly, the document shared on the operation input receiving device 2 can be stored in the information processing terminal 3A.

Here, the transmission operation may be performed using an image of the operation input receiving device 2 imaged by the imaging device 6. In this case, for example, the method disclosed in “Hand Gesture User Interface by Natural Hand Gesture”, Ike, et al., Toshiba Review Vol. 67 No. 6 (2012) may be used.

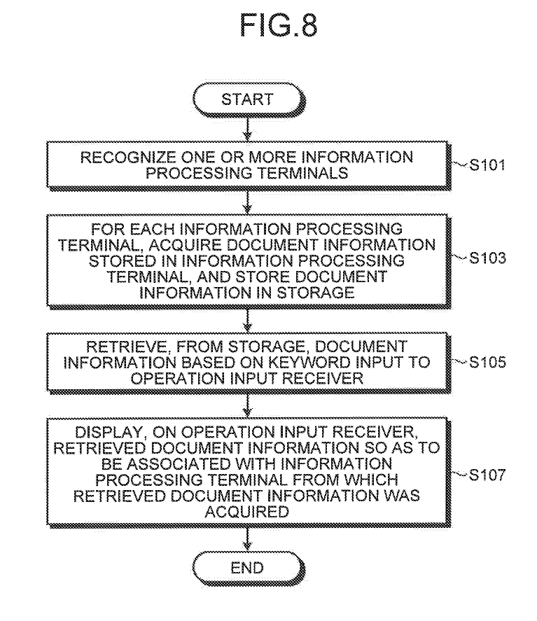

FIG. 8 is a flow chart diagram illustrating an example of a flow of a process procedure performed in the display system 1 according to the first embodiment.

First, when one or more information processing terminals 3 are placed on the operation input receiving device 2, the recognizer 11 recognizes the one or more information processing terminals 3 (step S101).

Subsequently, the document information acquirer 13 acquires, from each of the one or more information processing terminals 3, document information stored in the information processing terminal 3, and stores the acquired document information in the storage 15 (step S103).

Subsequently, the execution controller 17 retrieves, from the storage 15, document information based on a keyword that is input to the operation input receiving device 2 (step S105).

Subsequently, the projector 5 displays, on the operation input receiving device 2, the document information retrieved by the execution controller 17 so as to be associated with the information processing terminal 3 from which the retrieved document information is acquired by the document information acquirer 13 (step S107).

As described above, according to the first embodiment, the result of retrieval performed by the operation input receiving device 2 and the PC 4 is displayed so as to be associated with the information processing terminal 3. Therefore, the result of interactive exchange can be displayed in a manner that such interactive relation is understood.

### Modification 1 of First Embodiment

In the first embodiment, the retrieval of document information may be limited.

For example, the execution controller 17 may be configured to retrieve the document information based on the keyword, from the document information that is stored in the storage 15 and that is acquired from the information processing terminal 3 satisfying a predetermined condition among one or more information processing terminals 3.

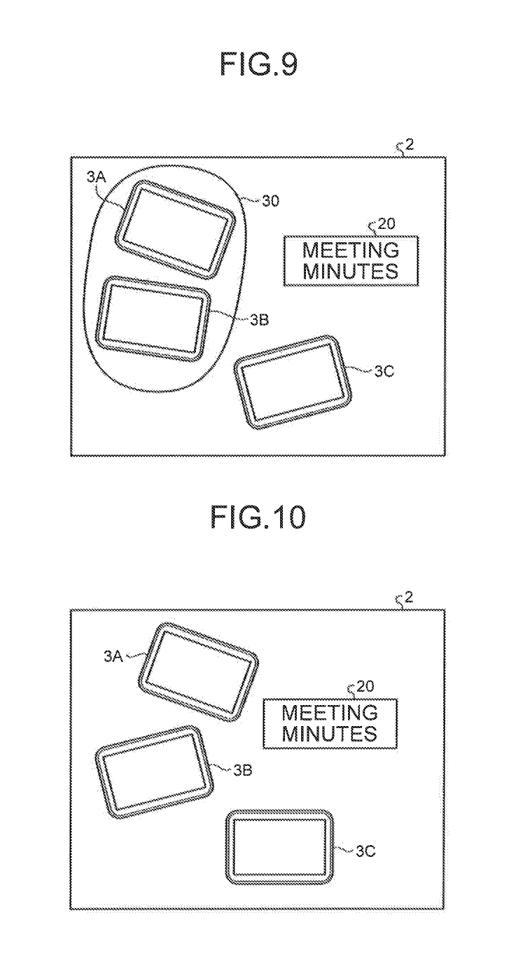

The information processing terminal 3 satisfying a predetermined condition may be, as illustrated in FIG. 9, information processing terminals 3A and 3B surrounded by a trace 30 on the operation input receiving device 2, among information processing terminals 3A to 3C; or may be, as illustrated in FIG. 10, information processing terminals 3A and 3B directed toward the search box 20, among information processing terminals 3A to 3C.

In a case of the example illustrated in FIG. 9, the PC 4 can acquire the position information of the trace 30 input from the operation input receiving device 2 to identify the information processing terminals 3A and 3B surrounded by the trace 30. In a case of the example illustrated in FIG. 10, the PC 4 can calculate the longitudinal direction for each of the information processing terminals 3A to 3C from the position information thereof to identify the information processing terminals 3A and 3B directed toward the search box 20 depending on whether or not the longitudinal direction crosses the search box 20. Here, the information processing terminals 3 directed toward the search box 20 may be identified using an image of the operation input receiving device 2 imaged by the imaging device 6. Alternatively, the information processing terminals 3 directed toward the search box 20 may be identified based on the position information of a plurality of IC tags that are provided to the information processing terminals 3A to 3C.

### Second Embodiment

In the second embodiment, an example of performing retrieval using an information processing terminal will be described. In the following, differences from the first embodiment are mainly described. Constituents having the same functions as in the first embodiment are assigned with names and reference numerals similar to those in the first embodiment, and descriptions thereof are omitted.

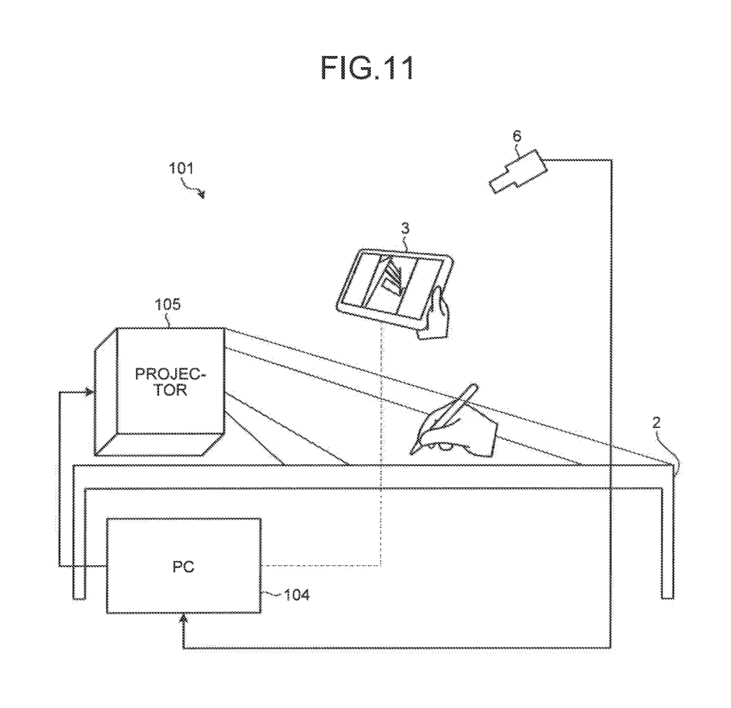

FIG. 11 is a schematic diagram illustrating an example of a display system 101 according to the second embodiment. As illustrated in FIG. 11, in the second embodiment, a PC 104 and a projector 105 are different from the first embodiment.

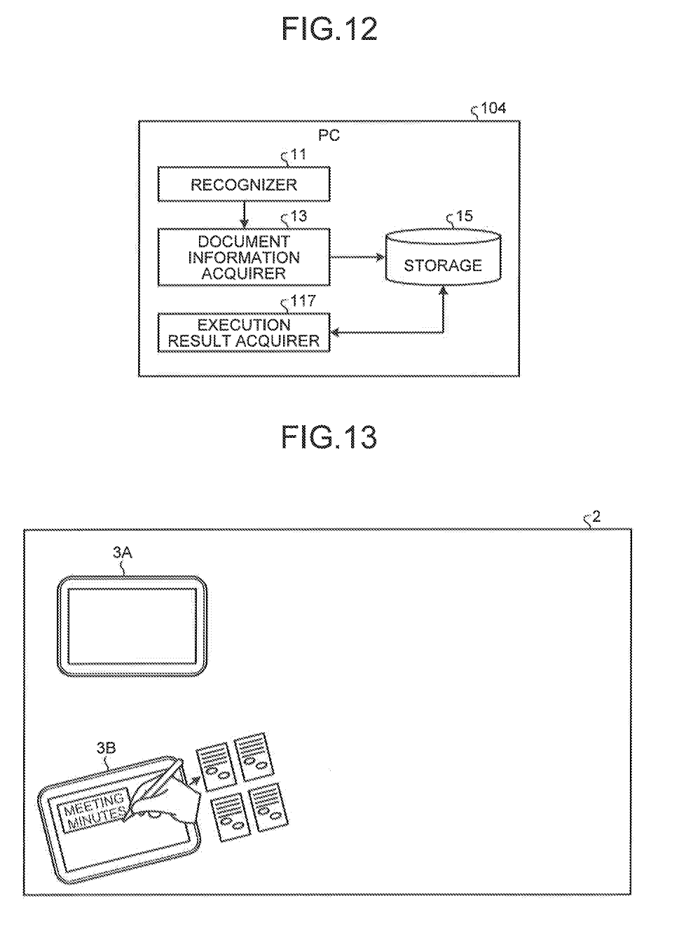

FIG. 12 is a configuration diagram illustrating an example of the PC 104 according to the second embodiment. As illustrated in FIG. 12, the second embodiment is different from the first embodiment in that the PC 104 includes an execution result acquirer 117, and does not include the execution controller 17 and the transmitter 19.

The execution result acquirer 117 acquires an execution result of a command executed by at least any of one or more information processing terminals 3. In the second embodiment, keyword retrieval is performed for the document information stored in the information processing terminal 3 itself. Therefore, the execution result acquirer 117 acquires retrieval result information which indicates a result of document information retrieval executed by at least any of one or more information processing terminals 3, and acquires from the storage 15 the document information based on the retrieval result information.

The retrieval result information is, for example, information identifying the retrieved document information. An example thereof may include a page number. In this case, the execution result acquirer 117 may acquire the retrieval result itself (the retrieved document information) instead of the retrieval result information, from the information processing terminal 3.

Here, the projector 105 will be described. The projector 105 displays, on the operation input receiving device 2, the command execution result acquired by the execution result acquirer 117 so as to be associated with at least any of one or more information processing terminals 3. Specifically, the projector 105 displays, on the operation input receiving device 2, the document information acquired by the execution result acquirer 117 so as to be associated with the information processing terminal 3 by which the retrieval of the acquired document information was executed. Here, the projector 105 displays, on the operation input receiving device 2, the acquired document information on a basis of the size of the information processing terminal 3 by which the retrieval of for the acquired document information was executed. More specifically, the acquired document information may be displayed by dividing the acquired document into plural pieces on a basis of the size of the casing of the information terminal, or may be displayed by setting as a display region a region that is substantially equivalent to the region of the casing.

For example, as illustrated in FIG. 13, the projector 105 projects, on the operation input receiving device 2, the document information acquired from the information processing terminal 3B among the document information acquired by the execution result acquirer 117, such that the document information is located around the information processing terminal 3B. In this situation, the projector 105 displays the document information acquired from the information processing terminal 3B on the operation input receiving device 2 on a basis of the size of the information processing terminal 3B. Accordingly, the display size of the document information is smaller than that in the first embodiment, and the region to be used and shared with other users on the operation input receiving device 2 can be ensured. Here, the PC 4 may previously acquire the size of the information processing terminal 3 from the information processing terminal 3.

When a transmission operation for transmitting document information displayed on the operation input receiving device 2 to a region where any of one or more information processing terminals 3 do not exist is performed on the operation input receiving device 2, the projector 105 displays the document information on the region on a basis of the size of the operation surface of the operation input receiving device 2.

For example, in FIG. 13, when the document information displayed around the information processing terminal 3B is transmitted by the transmission operation to a region where any of the information processing terminals 3 do not exist, the projector 105 projects the document information on the region on a basis of the size of the operation surface of the operation input receiving device 2.

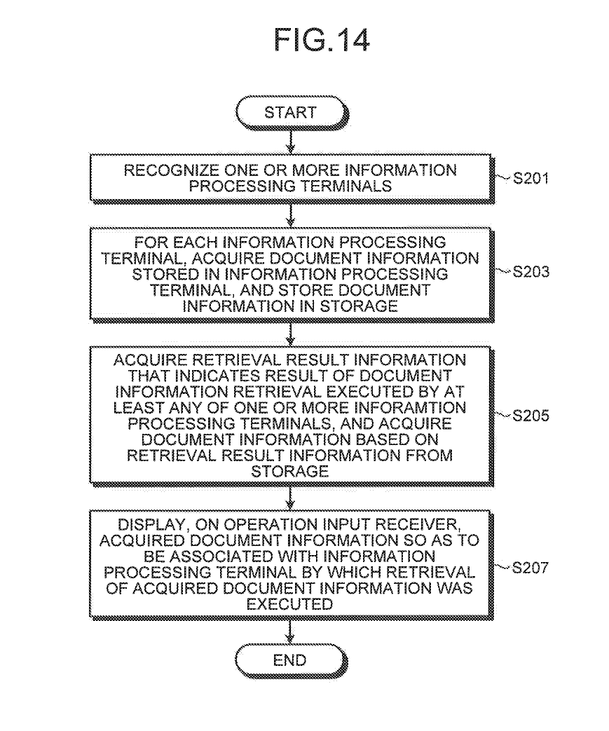

FIG. 14 is a flow chart diagram illustrating an example of a flow of a process procedure performed in the display system 101 according to the second embodiment.

First, when one or more information processing terminals 3 are placed on the operation input receiving device 2, the recognizer 11 recognizes the one or more information processing terminals 3 (step S201).

Subsequently, the document information acquirer 13 acquires, from each of the one or more information processing terminals 3, document information stored in the information processing terminal 3, and stores the acquired document information in the storage 15 (step S203).

Subsequently, the execution result acquirer 117 acquires retrieval result information which indicates a result of document information retrieval executed by at least any of one or more information processing terminals 3, and acquires from the storage 15 the document information based on the retrieval result information (step S205).

Subsequently, the projector 105 displays, on the operation input receiving device 2, the document information acquired by the execution result acquirer 117 so as to be associated with the information processing terminal 3 by which the retrieval of the acquired document information was executed (step S207).

As described above, according to the second embodiment, the retrieval result performed by the information processing terminal 3 is displayed on the operation input receiving device 2 in an association manner. Therefore, the result of interactive exchange can be displayed in a manner that such interactive relation is understood.

### Modification 1 of Second Embodiment

In the second embodiment, the execution of a command performed in the information processing terminal 3 may be formatting of hand-written data instead of the retrieval.

In this case, the execution result acquirer 117 acquires a result of hand-written data formatting executed by at least any of one or more information processing terminals 3, and the projector 105 displays, on the operation input receiving device 2, the formatting result acquired by the execution result acquirer 117 so as to be associated with the information processing terminal 3 by which the formatting for the formatting result was executed.

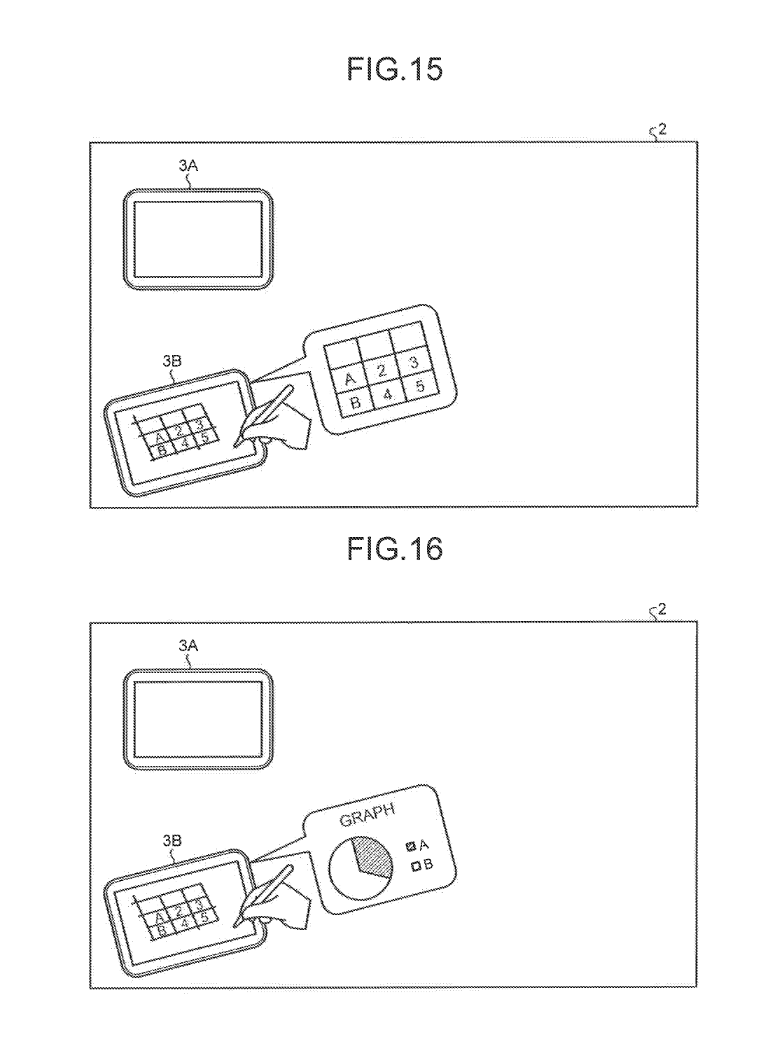

For example, as illustrated in FIG. 15, the projector 105 projects, on the operation input receiving device 2, the formatting result of a table acquired from the information processing terminal 3B by the execution result acquirer 117, such that the formatting result is located around the information processing terminal 3B. In this situation, the projector 105 displays, on the operation input receiving device 2, the formatting result of the table acquired from the information processing terminal 3B on a basis of the size of the information processing terminal 3B.

Here, the formatting result may be a transformed hand-written figure or table instead of a formatted hand-written figure or table. For example, as illustrated in FIG. 16, the formatting result may be a graph transformed from a hand-written table.

Although the description herein is based on an assumption of performing formatting on the information processing terminal 3 side, the formatting may be performed on the PC 4 side. Furthermore, when a correction operation to the formatting result displayed on the operation input receiving device 2 is performed on the operation input receiving device 2, the execution result acquirer 117 may correct the formatting result, and the projector 105 may display the corrected formatting result on the operation input receiving device 2 so as to be associated with the information processing terminal 3 by which the formatting of the formatting result was performed.

Furthermore, when a transmission operation for transmitting the formatting result displayed on the operation input receiving device 2 to a region where any of one or more information processing terminals 3 do not exist is performed on the operation input receiving device 2, the projector 105 displays the formatting result on the region on a basis of the size of the operation surface of the operation input receiving device 2.

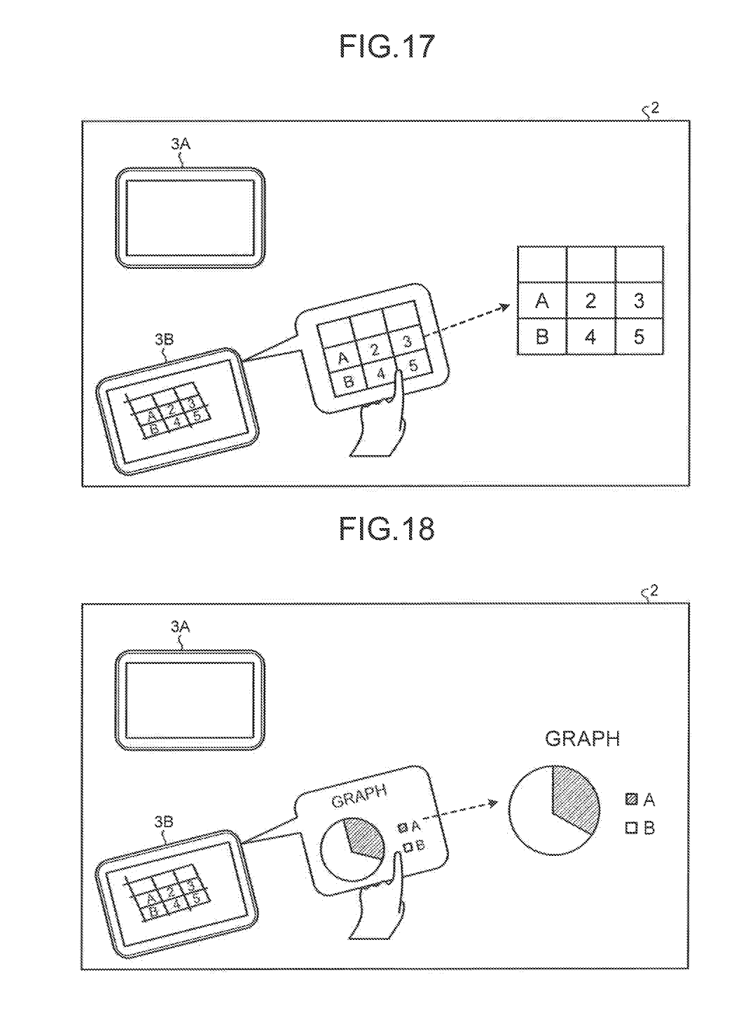

For example, in FIG. 17 and FIG. 18, when the formatting result displayed around the information processing terminal 3B is transmitted in response to the transmission operation to the region where any of the information processing terminals 3 do not exist, the projector 105 projects the formatting result on the region on a basis of the size of the operation surface of the operation input receiving device 2.

### Modification 2 of Second Embodiment

In the second embodiment, when the information processing terminal 3 being associated with the execution result of a command is held up from the operation input receiving device 2, the projector 105 may display the execution result of a command on a region where the information processing terminal 3 is projected on the operation input receiving device 2.

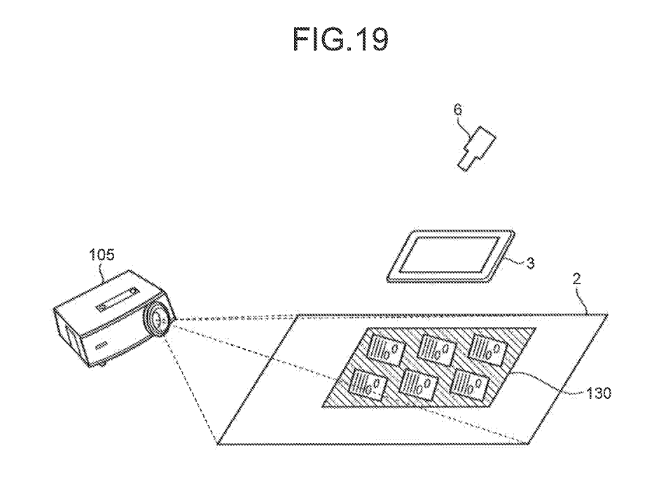

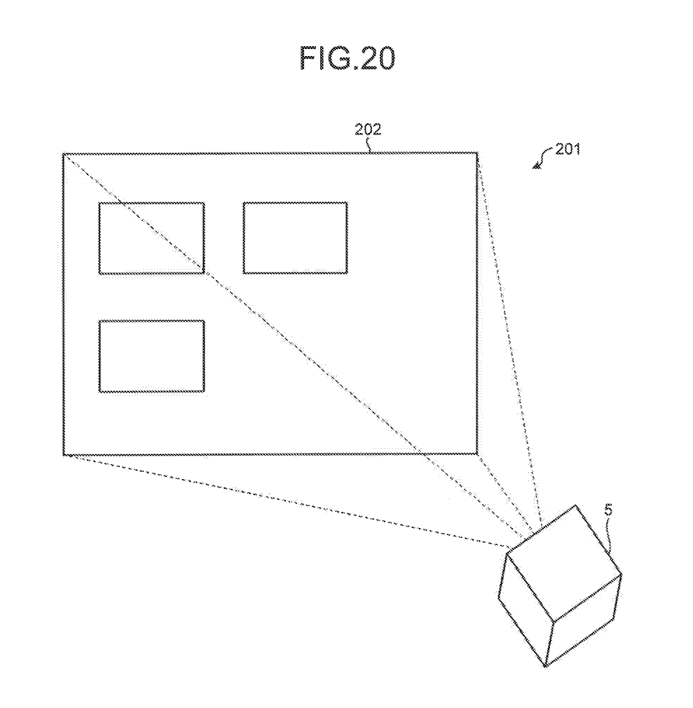

For example, as illustrated in FIG. 19, when the information processing terminal 3 is held up from the operation input receiving device 2, the retrieved document information may be projected on a region 130 where the information processing terminal 3 is projected on the operation input receiving device 2.

In this case, judgment on whether or not the information processing terminal 3 is held up from the operation input receiving device 2 can be made from the change in size of the information processing terminal 3 in an image of the operation input receiving device 2 imaged by the imaging device 6. As the base point of the region where the information processing terminal 3 is projected on the operation input receiving device 2, the imaging device 6 may be used.

Accordingly, since the retrieved document information is displayed around the region where the information processing terminal 3 was placed, a larger region of the operation input receiving device 2 can be ensured to be used and shared with other users.

Here, the method according to the second modification can be also applied to the display of the formatting result of hand-written data.

### Modification 1 of All Embodiments

In the above-described embodiments, an example in which the operation input receiving device 2 is a table has been described. However, like a display system 201 illustrated in FIG. 20, the operation input receiving device 202 may be an electronic blackboard, a whiteboard having a touch panel display, and the like.

### Modification 2 of All Embodiments

In the above-described embodiments, a projector is used to project an image on the operation input receiving device 2. However, the operation input receiving device 2 may be configured to display an image. In this case, a projector is not necessary, and a PC may also perform display control to the operation input receiving device 2.

Hardware Configuration

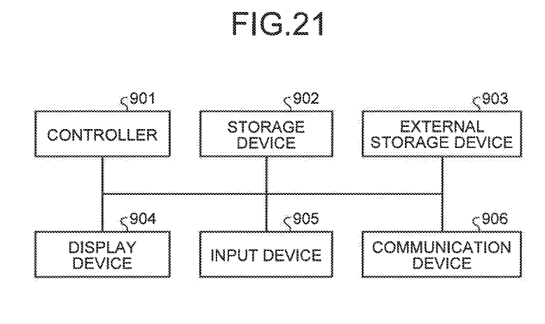

FIG. 21 is a diagram illustrating an example of a hardware configuration of a PC according to the embodiments and modifications described above. The PC according to the embodiments and modifications described above includes a controller 901 such as a CPU, a storage device 902 such as a ROM and a RAM, an external storage device 903 such as an HDD, a display device 904 such as a display, an input device 905 such as a keyboard and a mouse, and a communication device 906 such as a communication interface, and has a hardware configuration utilizing a common computer.

Programs to be executed in the PC according to the embodiments and modifications described above are provided by being stored in a storage medium that can be read by a computer in a file of an installable format or an executable format. Examples of such a storage medium may include a CD-ROM, a CD-R, a memory card, a DVD (Digital Versatile Disk), and flexible disk (FD).

Also, the programs to be executed in the PC according to the embodiments and modifications described above may be provided by being stored on a computer connected to a network such as the Internet and being downloaded through the network. Also, the programs to be executed in the PC according to the embodiments and modifications described above may be provided or distributed through a network such as the Internet. Also, the programs to be executed in the PC according to the embodiments and modifications described above may be provided by being previously incorporated into a ROM or the like.

The programs to be executed in the PC according to the embodiments and modifications described above have a module structure for realizing the above-described units on the computer. As actual hardware, a CPU retrieves a program from an HDD onto a RAM, and executes the retrieved program, to realize the above-described units on the computer.

The steps in the flowcharts of the above-described embodiments may be changed in an execution order, plurally executed in a simultaneous manner, or executed in a different order for each implementation, unless the nature of the steps is not impaired.

According to the embodiments and modifications described above, the result of interactive exchange can be displayed in a manner that such interactive relation is understood.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display system comprising:
an operation input receiver configured to receive an operation input;
a recognizer configured to recognize one or more information processing terminals placed on the operation input receiver;
an execution controller configured to execute a command based on the operation input that is performed through the operation input receiver; and
a display controller configured to display, on the operation input receiver, an execution result of the command so as to be associated with at least any of the one or more information processing terminals.

2. The system according to claim 1, further comprising
a document information acquirer configured to acquire, from each of the one or more information processing terminals, document information stored in the information processing terminal, and store the acquired document information in a storage, wherein
the execution controller is configured to retrieve document information from the storage based on a keyword that is input to the operation input receiver, and
the display controller is configured to display, on the operation input receiver, the retrieved document information so as to be associated with the information processing terminal from which the retrieved document information is acquired.

3. The system according to claim 2, wherein the display controller is configured to display, on the operation input receiver, the retrieved document information on a basis of a size of an operation surface of the operation input receiver.

4. The system according to claim 2, wherein the execution controller is configured to retrieve the document information based on the keyword, from document information stored in the storage and acquired from an information processing terminal satisfying a predetermined condition among the one or more information processing terminals.

5. The system according to claim 2, further comprising a transmitter configured to, when a transmission operation for transmitting the document information displayed on the operation input receiver to at least any of the one or more information processing terminals is performed on the operation input receiver, transmit the document information to the information processing terminal.

6. The system according to claim 1, wherein the one or more information processing terminals each include an operation display configured to receive an operation input and display an image.

7. A display system comprising:
an operation input receiver configured to receive an operation input and display an image;
a recognizer configured to recognize one or more information processing terminals placed on the operation input receiver;
an execution result acquirer configured to acquire an execution result of a command executed by at least any of the one or more information processing terminals; and
a display controller configured to display, on the operation input receiver, the execution result of the command so as to be associated with at least any of the one or more information processing terminals.

8. The system according to claim 7, further comprising
a document information acquirer configured to acquire, for each of the one or more information processing terminals, document information stored in the information processing terminal, and store the acquired document information in a storage, wherein
the execution result acquirer is configured to acquire retrieval result information that indicates a result of document information retrieval executed by at least any of the one or more information processing terminals, and acquire document information based on the retrieval result information from the storage, and
the display controller is configured to display, on the operation input receiver, the acquired document information so as to be associated with the information processing terminal by which the retrieval of the acquired document information was executed.

9. The system according to claim 8, wherein the display controller is configured to display, on the operation input receiver, the acquired document information on a basis of a size of the information processing terminal by which the retrieval of the acquired document information was executed.

10. The system according to claim 9, wherein, when a transmission operation for transmitting the document information displayed on the operation input receiver to a region where any of the one or more information processing terminals do not exist is performed on the operation input receiver, the display controller is configured to display the document information on the region on a basis of a size of an operation surface of the operation input receiver.

11. The system according to claim 7, wherein
the execution result acquirer is configured to acquire a formatting result of hand-written data indicating a result of hand-written data formatting executed by at least any of the one or more information processing terminals, and
the display controller is configured to display, on the operation input receiver, the acquired result of formatting so as to be associated with the information processing terminal by which the formatting for the acquired formatting result was executed.

12. The system according to claim 11, wherein the display controller is configured to display, on the operation input receiver, the acquired formatting result on a basis of a size of the information processing terminal by which the formatting for the formatting result was executed.

13. The display system according to claim 12, wherein, when a transmission operation for transmitting the formatting result displayed on the operation input receiver to a region where any of the one or more information processing terminals do not exist is performed on the operation input receiver, the display controller is configured to display the formatting result on the region on a basis of a size of an operation surface of the operation input receiver.

14. The system according to claim 11, wherein,
when a correction operation to the formatting result displayed on the operation input receiver is performed on the operation input receiver, the execution result acquirer is configured to correct the formatting result, and
the display controller is configured to display, on the operation input receiver, the corrected formatting result so as to be associated with the information processing terminal by which the formatting for the formatting result was executed.

15. The system according to claim 7, wherein the one or more information processing terminals each include an operation display configured to receive an operation input and displays an image.

16. The system according to claim 7, wherein, when the information processing terminal associated with the execution result of the command is held up from the operation input receiver, the display controller is configured to display the execution result of the command on a region where the information processing terminal is projected on the operation input receiver.

17. A display control device, comprising:
a recognizer configured to recognize one or more information processing terminals placed on an operation input receiver, the operation input receiver receiving an operation input and displaying an image;
an execution controller configured to execute a command based on an operation input receive by the operation input receiver; and
a display controller configured to display, on the operation input receiver, an execution result of the command so as to be associated with at least any of the one or more information processing terminals.

18. A display control device, comprising:
a recognizer configured to recognize one or more information processing terminals placed on an operation input receiver, the operation input receiver receiving an operation input and displaying an image;
an execution result acquirer configured to acquire the execution result of a command executed by at least any of the one or more information processing terminals; and
a display controller configured to display, on the operation input receiver, the execution result of the command so as to be associated with at least any of the one or more information processing terminals.
